(19) United States
(12) Patent Application Publication
(10) Pub. No.: US 2022/0138027 A1
(43) Pub. Date: May 5, 2022

(54) METHOD FOR TRANSMITTING A MESSAGE IN A COMPUTING SYSTEM, AND COMPUTING SYSTEM

(71) Applicant: Siemens Aktiengesellschaft, 80333 München (DE)

(72) Inventor: Rene Graf, Zirndorf (DE)

(73) Assignee: Siemens Aktiengesellschaft, 80333 München (DE)

(21) Appl. No.: 17/429,889

(22) PCT Filed: Feb. 5, 2020
(86) PCT No.: PCT/EP2020/052855

§ 371 Date: Aug. 10, 2021

(30) Foreign Application Priority Data
Feb. 11, 2019 (EP) 19156405.3

(51) Int. Cl. G06F 9/54; G06F 12/0802; G06F 12/109

(52) U.S. Cl. CPC G06F 9/546; G06F 12/109; G06F 12/0802

(57) ABSTRACT

In a method for transmitting a message in a computing system, the message is transmitted by a transmitter and received by a receiver. The transmitter is granted access to a memory area for the purpose of transmitting using a first virtual address allocated to the transmitter by a memory management unit, whereas the access to the memory area by the transmitter is revoked after transmitting. Subsequently, the receiver is granted access to the memory area for the purpose of receiving using a second virtual address allocated to the receiver by a memory management unit. The first virtual address may be different from the second virtual address.

The present invention relates to a method for transferring a message in a computing system. The method comprises the transmitting of the message using a transmitter, wherein in order to transmit the message by means of the transmitter, data is written into one memory area of a plurality of memory areas. Furthermore, the method comprises the receiving of the message using a receiver, wherein in order to receive the message the data is read by means of the receiver in the memory area. Moreover, the present invention relates to a computing system. The invention additionally relates to a computer program as well as a computer-readable medium.

In computing systems with a plurality of execution levels, the individual software units, for example tasks, communicate with one another very often via messages, in order to exchange events and data. In the computing systems, in this context, a distinction is made between two types of orchestration of multiple tasks, which may occur in a mixed form, namely threads and processes. In this context, threads run within an address space, which is referred to as a process. For this reason, within a process, all threads see the identical memory. Between two processes, however, there is initially no shared memory, meaning that the same (virtual) memory address refers in different processes to different areas in the physical memory. The two orchestration options described also involve two different options for exchanging messages.

Intra-process communication is known from the prior art. Here, within one process, all threads see the same memory, meaning that a message does not have to be copied between transmitter and receiver, but rather only the pointer (virtual memory address) has to be sent to it, in order for the receiver to be able to access the content. The major advantage here is both the high speed of the data exchange, as only a few bytes have to be sent, as well as the deterministic nature of the transmission, as it does not depend upon the size of the message. By way of contrast, however, there is the major disadvantage that the memory of the message and therefore the integrity of the content thereof is not protected. Following the transmission, the transmitter can have write access to said memory and can modify the content. The receiver does not have the option of identifying this modification in relation to the point in time of the sending.

Furthermore, inter-process communication is known. During communication by means of messages between processes, however, these always have to be copied due to the disjoint address ranges. For this purpose, the message mechanism of the operating system provides a corresponding memory area therein, so that during transmission the message first has to be copied from the memory of the transmitter into the memory of the system. Following delivery, this message is in turn copied from the system memory into the memory of the receiver. In addition to this duplicated time delay, the method has the further disadvantage that the number of memory blocks available in the system may not be sufficient, meaning that the transmitter freezes, because it cannot copy the message. It is not possible to increase the number of blocks retroactively. Additionally, the time span of the copying is dependent upon the length of the message and is therefore not deterministic. The major advantage of this copying message mechanism is instead that of fully ensuring the integrity of the message, as it can no longer be modified following the transmission.

Due to the duplicated copying of the message memory, the inter-process communication is on the one hand in any case considerably slower than the copying of a pointer. On the other hand, the copying is also dependent upon the length of the message and therefore can only be estimated with twice the worst-case time of the maximum copy time above defined by the size of the system memory areas. Transmitting a pointer, however, always takes exactly the same amount of time and is therefore entirely deterministic. This means that intra-process communication is also suitable for use in a real-time system, while inter-process communication is only possible for non-real-time systems or non-real-time tasks (also within a real-time system).

Additionally, container virtualization is known from the prior art. Containers for isolating different tasks are likewise based on processes, but offer further options for limiting the resource consumption, such as computing power or maximum available memory for example. Currently, containers are primarily used in computing systems because they are considerably more lightweight than virtual machines, but the increasing influence of the Internet of Things (loT) is also bringing container technology to devices which are not part of a computer cluster. Specifically in the field of automation, the paradigms of container (isolation of different tasks) and real-time (deterministic time behavior for monitoring a physical procedure) come together.

In a system with container virtualization, only the inter-process communication described above can be used, as the base system isolates the containers from one another from a memory perspective. Accordingly, all the disadvantages of this message exchange take effect in full, primarily the higher and non-deterministic running time. For this reason, only non-real-time tasks can be isolated from one another in containers, while the real-time tasks cannot be isolated from one another without having a severe negative impact on the time behavior. As there is at present no solution for deterministic communication between containers, this technology cannot be used in automation devices or other real-time systems.

U.S. Pat. No. 7,152,231 B1 discloses a method for inter-process communication, comprising the steps: detecting a previously created shared region of RAM, creating and configuring a shared region of RAM for storing accumulated data, and attaching a first and a second process to a message buffer in the shared region of the RAM, wherein each process has a message list, which is a message queue, accumulating message data from the first process at a location in the message buffer, wherein the first process adds a memory offset, which corresponds to the location in the message buffer, to the memory list of the second process, and manipulating the accumulated data in the second process at the location that corresponds to the offset, whereby the accumulated message data is transferred from the first process to the second process with minimal data transfer outlay.

Additionally, U.S. Pat. No. 8,286,188 B1 describes an inter-process memory controller, which can be used in order to enable a plurality of processes in a multi-process device to have access to a shared physical memory. The described inter-process memory controller may constrain access rights to shared memory which has been allocated to the respective processes, whereby the multi-process apparatus is protected from instability due to unauthorized overwriting and/or unauthorized release of allocated memory.

The object of the present invention is to demonstrate a solution of how the message transfer can take place in a more reliable manner in a computing system.

This object is achieved according to the invention by a method, by a computing system, by a computer program as well as by a computer-readable (storage) medium with the features in accordance with the independent claims. Advantageous developments are disclosed in the dependent claims.

A method according to the invention is used to transfer a message in a computing system. The method comprises the transmitting of the message using a transmitter, wherein in order to transmit the message by means of the transmitter, data is written into one memory area of a plurality of memory areas. Furthermore, the method comprises the receiving of the message using a receiver, wherein in order to receive the message the data is read by means of the receiver in the memory area. In this context, it is provided that the transmitter is granted access to the memory area for the transmission. Furthermore, the access of the transmitter to the memory area is revoked after the transmission. Subsequently, the receiver is granted access to the memory area for the receiving.

With the method, a message or data is intended to be transferred from a transmitter to a receiver. The transmitter and receiver may involve a task, a process or a container. The method in particular involves a computer-implemented method which is carried out on a computing system. The computing system may be a computer or a different data processor. The computing system may also be part of an automation device, which may be used in automation and/or manufacturing, for example.

In order to transfer the message, a memory area is used. This memory area may be provided in the manner of what are known as pages. For each message, one such page is used in order to store the data therein. Each process or task may be both transmitter and receiver for such messages. As a first step, the transmitter may retrieve a memory area from a base system, in order to then write its data into it. With the transmission of the message, the access of the transmitter to this memory area is revoked again and access is transferred to the receiver. This makes it possible to implicitly ensure that the transmitter is no longer able to modify the message after transmission, which ensures full integrity of the message. Inadvertent use of the memory due to a programming error is also excluded, as each access to the memory leads to an exception handling, because the process accesses a virtual address that is invalid for it and is not occupied by physical memory.

According to the invention, a message mechanism is therefore provided, which combines the crucial advantages of intra-process communication and inter-process communication, without having the disadvantages thereof. In other words, it is therefore possible to achieve full integrity of the message with simultaneous rapid and deterministic transmission. A main aspect of this invention lies in the combination of the deterministic delivery, which previously was only possible in intra-process communication, with the full integrity of the message, as it is neither intended nor possible to retroactively modify the content after the transmission.

Moreover, the transmitter is allocated a first virtual address for access to the memory area and the receiver is allocated a second virtual address for access to the memory area, wherein the first virtual address differs from the second virtual address. The physical memory of the message may appear at a different virtual address for the receiver than for the transmitter. In this context, the receiver may obtain the address that is correct for it from the base system. Following the reading of the message, the receiver can either return the memory area to the base system or directly use it again for transmitting another message. By switching the virtual address, the integrity of the message is ensured, even when using this mechanism for message exchange within a process, as the transmitter is not able to know the new virtual address and thus cannot access it. Therefore, this method for message exchange enables the separation of different tasks of a real-time system into different processes (address ranges), in order to protect these from one another. This is primarily of importance in the consolidation of multiple applications on one device, in order to avoid unknown dependencies.

In one embodiment, the plurality of memory areas are provided by means of a memory management unit, wherein the respective memory areas have a predetermined memory size. The memory management unit may also be referred to as MMU. Modern computing systems, including automation devices, usually have an MMU which substantially undertakes the logical assignment of the physically available main memory to virtual addresses, meaning that different software units optionally have the same or different views of the memory. Two (or more) processes may also have access to the same physical memory, which however then may also appear under different addresses in the respective processes. The memory management unit may generally make the physical memory available to the respective processes in the manner of a page. The page size typically amounts to four kilobytes (4096 bytes), wherein some processor systems also permit other page sizes, in part even simultaneously.

It may further be provided that what is known as a pool (often also memory pool) is used. A pool refers to a memory management method, in which, during the initialization of the system, a certain number of memory blocks of equal size are allocated and stored in this pool. The provision of a memory area from this pool, however, is entirely deterministic, as this is managed in an internal list as a general rule and therefore only the first element from this list always has to be taken therefrom.

In a further embodiment, the memory size of at least some of the plurality of memory areas differs. In order to manage memory blocks or memory areas with different sizes, multiple pools or message pools can be created. For example, one pool can be created per memory size, meaning that the transmitter can refer to one of the pools in a targeted manner, in order to receive a memory area in the required size. For example, the base system may allocate a defined number of memory areas in the initialization of the overall system. If the processor supports different MMU page sizes or memory areas with different memory sizes in parallel, it is also possible for pools with different sizes to be created, which however in each case always correspond to a defined page size of the MMU.

Furthermore, it is advantageous if the plurality of memory areas are allocated for the transfer of the message. For transmission, a new memory area or a new page can be retrieved from the system, in order to be able to use it as a transmission buffer. The running time of this function is not deterministic. The memory allocation is a non-deterministic procedure, even in a real-time system, as it depends upon the current system and memory state and therefore can only be estimated with a maximum running time, which is too great for a real-time system, however.

In a further embodiment, the plurality of memory areas are provided in a message queue. Such a message queue may also be referred to as a message waiting list. Message queues are used to manage the individual messages. In this context, the queues are in particular not assigned to a task in a fixed manner, but rather this depends upon the principle. The fact that a particular task can be reached via one or more message queues is stipulated as a convention during the definition of the system. Likewise, separate message queues can be assigned to the base system itself. In order for the message queue to be available to the transmitter and/or receiver for use, it is preferably provided that the message queue is initialized. The transmitter and/or the receiver can therefore address the message queue at a later point, in order to transmit or receive.

Furthermore, it is advantageous if the memory area is transferred to the message queue following the transmission by means of the transmitter and, for receiving purposes, a content of the memory area is removed from the message queue by means of the receiver. Following the transmission, the memory area or the transmission buffer can be transferred to the message queue, so that another task can take it from the message queue. This function can never freeze as there is no upper limit as to how many transmission buffers or memory areas can be in a message queue before it is read.

During receiving, the following situation may arise: a task or the receiver wishes to remove the first buffer from a message queue. If the message queue is empty, the task freezes until a buffer is transmitted into the queue from another task. In order for the freezing not to last forever, the receiving function may also offer a timeout or a try option, so that the freezing only lasts a certain amount of time or never occurs. In the event of the function returning without a buffer, a corresponding error code can be returned.

Should the transmitter wish to transmit the message, it requires one of these blocks or memory areas for this purpose. To this end, the transmitter is able to activate a receiving function applied to the pool message queue, and obtains a block for further use. If there are no longer any free blocks available in the system, then the mechanisms described engage such that the task optionally does not freeze, freezes for a limited amount of time or freezes in a lasting manner.

In a further embodiment, the memory area is released following the receiving. Following the receiving, the memory area can be returned to the system and therefore to the general system memory. This running time of this function is not deterministic. A memory area which is no longer required may be transmitted to the pool message queue, so that this is available to other tasks again. It may further be provided that the message queue is removed from the system again. Buffers available therein may either be implicitly released or the removal is rejected, provided that there are still buffers therein. A task which is waiting for a buffer in this queue, can be woken and can return with the error code for no new message.

The above functions for allocating and/or releasing can be dispensed with during the complete use of message pools, wherein the initialization function then allocates a defined number of buffers in an implicit manner, and the removing function releases these in an implicit manner. If necessary, a reallocation may be possible at runtime.

In a further embodiment, a task, a process and/or an application in a container are used as transmitter and/or receiver. It is therefore possible to use a transmit task as transmitter and a receive task as receiver. The method can therefore be used for intra-process communication. It is therefore also possible to use a transmit process as transmitter and a receive process as receiver. The method can therefore be used for inter-process communication. Moreover, containers can be used as transmitter and receiver. The message mechanism can be provided by the base system, to which both simple processes and containers may have access. Furthermore, this method also enables the deterministic communication between applications isolated in containers, which was not possible until now. This makes it possible to use containers for application management in real-time systems. Even when using only a single process or container and mapping the individual tasks to threads within them, in addition to the deterministic nature, the full integrity is also retained, as the receiver thread is presented with the physical memory of the message buffer under a different virtual address.

Using this method also dispenses with the necessity of the transmitter having to know whether the receiver is running in the same or in a different process, as there are no longer any different message methods for these cases, but rather only a single one which covers all combinations.

The method differs in particular from methods in which there is provision for the use of a shared memory between the processes and the management thereof via semaphores or other synchronization means. Here too, there would be the option of only transmitting the pointer to the message content in the shared memory. The pointer would have to be corrected on an application basis, however, as the shared memory does not have to be at the same virtual address in each process. Furthermore, the transmission of a pointer between processes by way of the double-copy method is also neither rapid nor necessarily deterministic. The ensuring of the integrity can likewise only take place on an application basis while the described method according to the invention brings this implicitly as system performance without running time delay.

A computing system according to the invention is embodied for performing a method according to the invention and the advantageous embodiments thereof. In addition to conventional operating systems, this method may also be used in microkernel systems, in which almost all parts of the system run in separate processes, which, despite severely increasing the security, until now has led to considerable slowdown, specifically during the exchange of messages. For this reason, real-time tasks in such systems until now had been forced to run in the same process, in order to ensure the deterministic nature.

A computer program according to the invention comprises commands which, when the program is executed by a computing system, prompt it to carry out the method according to the invention and the advantageous embodiments thereof. A computer-readable (storage) medium according to the invention comprises commands which, when executed by a computing system, prompt it to carry out the method according to the invention and the advantageous embodiments thereof.

The preferred embodiments proposed in relation to the method according to the invention and the advantages thereof apply accordingly to the computing system according to the invention, the computer program according to the invention and the computer-readable (storage) medium according to the invention.

Further features of the invention are disclosed in the claims, the figures and the description of the figures. The features and combinations of features mentioned in the description above and the following features and combinations of features mentioned in the description of the figures and/or shown in the drawings alone can be used not only in the respective combination given, but also in other combinations without departing from the scope of the invention.

The invention will now be described in greater detail using preferred exemplary embodiments and making reference to the accompanying drawings, in which:

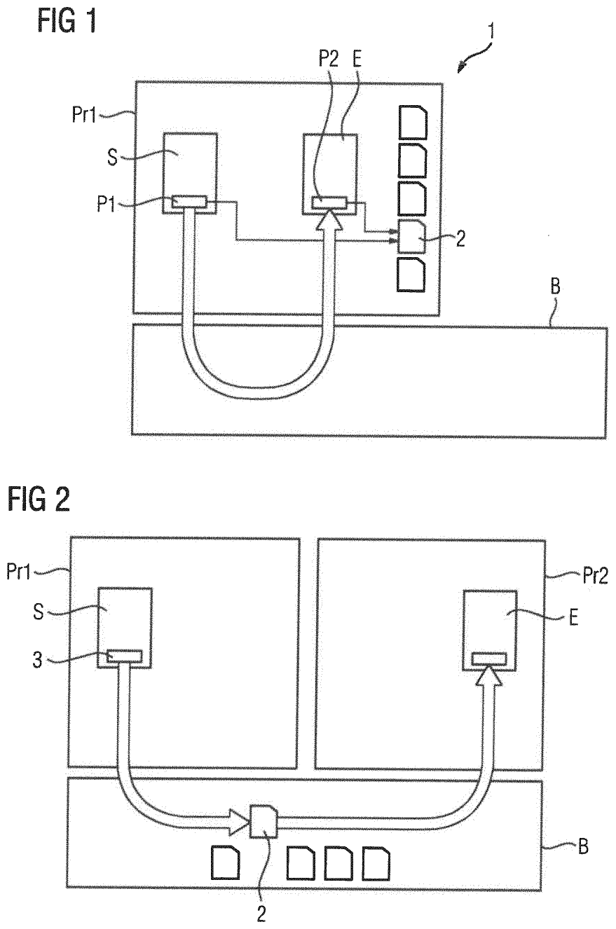

FIG. 1 shows a schematic representation of a computing system, by means of which an intra-process communication is performed in accordance with the prior art;

FIG. 2 shows a schematic representation of a computing system, by means of which an inter-process communication is performed in accordance with the prior art;

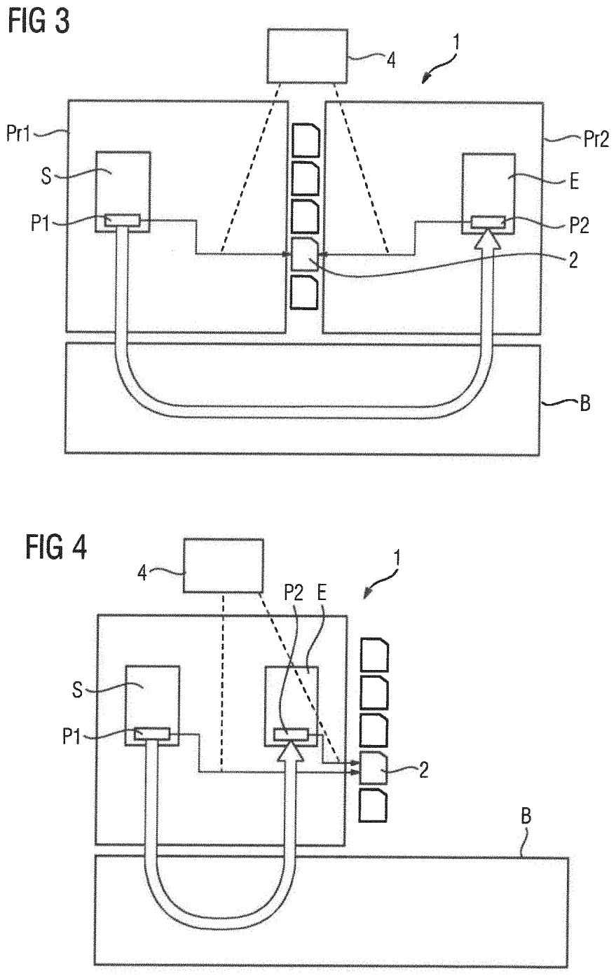

FIG. 3 shows a schematic representation of a computing system in accordance with a first embodiment, in which a message is transferred between two processes; and

FIG. 4 shows a schematic representation of a computing system in accordance with a second embodiment, in which a message is transferred within a process.

In the figures, identical or functionally similar elements are provided with the same reference characters.

FIG. 1 shows a schematic representation of a computing system 1, by means of which an intra-process communication is performed in accordance with the prior art. In this context, messages are to be transferred within a process Pr1. Here, data is to be transferred from a transmitter S in the form of a transmit task to a receiver E in the form of a receive task. The transmitting and receiving are performed by a base system B. Within the process P1, both the transmitter S and the receiver E each have access to memory areas 2 of a memory. It is not necessary in this context for the message or data to be copied. Here, it is sufficient if virtual memory addresses P1, P2 or pointers are transferred. In the present case, the transmitter S and the receiver E have identical memory addresses P1, P2. The advantage in the case of intra-process communication is the high speed of the data exchange, and the deterministic nature of the transmission, as this does not depend upon the size of the message. By way of contrast, however, there is the major disadvantage that the memory area 2 of the message and therefore the integrity of the content thereof is not protected.

In comparison, FIG. 2 shows a schematic representation of a computing system 1, by means of which an inter-process communication is performed in accordance with the prior art. In this context, the message or data 3 is transferred from the transmitter S or transmit task in a first process Pr1 to the receiver E or receive task in a second process Pr2. It is necessary here to copy the data to be transferred. To this end, the base system B provides the memory areas 2. For the transmission, the data 3 is copied from a memory of the transmitter S into the memory area 2. For the receiving, the data 3 is in turn copied from the memory area 2 into a memory of the receiver E. In addition to this doubled time delay, the inter-process communication has the further disadvantage that the number of memory areas 2 available in the system may not be sufficient, meaning that the transmitter S freezes, because it cannot copy the data 3. The advantage of inter-process communication is fully ensuring the integrity of the message, as it can no longer be modified following the transmission.

FIG. 3 shows a schematic representation of a computing system 1 in accordance with a first embodiment. Here, a message is transferred from the transmitter S in the first process Pr1 to the receiver E in the second process Pr2. Here, the computing system 1 moreover comprises a memory management unit 4, which can also be referred to as MMU. The memory management unit 4 undertakes the logical assignment of the physically available main memory to virtual addresses. By means of the memory management unit 4, the memory areas 2 can be provided as a page with a memory size of four kilobytes, for example.

For the transmission of the message, the transmitter S retrieves a memory area 2 from the base system B, in order to write the data into it. With the transmission of the message, the access of the transmitter S to this page is revoked again by MMU configuration and access is transferred to the receiver E. This means that the transmitter S is no longer able to modify the memory area 2 following the transmission. Moreover, the virtual addresses P1, P2 differ for the transmitter S and the receiver E. The receiver E may obtain the virtual address P2 from the base system B.

The method may also be used for message transfer in a single process Pr1. This is illustrated in FIG. 4, which shows a schematic representation of a computing system 1 in accordance with a further embodiment. By way of the different virtual addresses P1, P2, the integrity of the message is ensured during the message exchange within the process Pr1.

In order to be able to manage the messages, message queues are used. The message queue is first initialized. Furthermore, the allocation is performed. Here, a memory area 2 is provided, which can be used to transmit the message. The running time of this function is not deterministic. In this context, what are known as pools or memory pools can also be used. Here, during the initialization of the system, a certain number of memory areas 2 of equal size are allocated and stored in this pool. The provision of a memory area from this pool is deterministic.

For the transmission, the memory area 2 can be transferred to the message queue by means of the transmitter S. This function is never able to freeze as there is no upper limit as to how many transmission buffers can be in a message queue before it is read. For the receiving, the receiver E can remove the memory area 2 from the message queue. If the message queue is empty, the task freezes until a buffer is transmitted into the queue from another task. For the receiving function, a timeout or a try option may also be used, so that the freezing only lasts a certain amount of time or never occurs. After this, the memory area 2 can be released. This running time of this function is not deterministic. Finally, the message queue can be removed from the system again.

Using the method, both during the message transfer within a process Pr1 and during the message transfer between processes Pr1, Pr2, it is possible to realize on the one hand the full message integrity and on the other hand the deterministic delivery.

What is claimed is:

1.-11. (canceled)

12. A computer-implemented method for transferring a message in a computing system, comprising:
writing data into a memory area of a plurality of memory areas,
granting a transmitter, which is embodied as an application in a container, access to the memory area by using a memory management unit,
allocating to the transmitter a first virtual address by the memory management unit for access to the memory area,
transmitting the message using a transmitter,
revoking access of the transmitter to the memory area by the memory management unit after transmission of the message,
for receiving, granting a receiver, which is embodied as an application in a container, access to the memory area by allocating to the receiver a second virtual address obtained from the memory management unit for access to the memory area, with the first virtual address being different from the second virtual address, and
reading the data from the memory area with the receiver using the second virtual address.

13. The method of claim 12, wherein the plurality of memory areas, having each a predetermined memory size, are provided by the memory management unit.

14. The method of claim 13, wherein of at least some of the plurality of memory areas differ in memory size from others of the plurality of memory areas.

15. The method of claim 12, wherein the plurality of memory areas are allocated for transmitting the message.

16. The method of claim 12, wherein the plurality of memory areas are configured as a message queue.

17. The method of claim 16, further comprising:
transferring the memory area by the transmitter to the message queue following transmission of the message, and
for receiving with the receiver, removing by the receiver content of the memory area from the message queue.

18. The method of claim 12, further comprising releasing the memory area following receiving with the receiver.

19. A computing system, comprising:
a memory management unit providing a logical association of physical memory areas with virtual memory addresses,
a transmitter obtaining from a base system a physical memory area or obtaining from the memory management unit a first virtual memory address corresponding to the physical memory area and transmitting a message to the physical memory area,
a receiver obtaining from the memory management unit a second virtual memory address corresponding to the physical memory area, with the first virtual memory address being different from the second virtual memory address, and receiving the message stored in the physical memory area using the second virtual memory address.

20. A computer program product embodied in a non-transitory computer-readable storage medium and comprising commands which, when the commands are read into a memory of a computing system and executed by a processor of the computing system, cause the computing system to.
write data into a memory area of a plurality of memory areas,
grant a transmitter, which is embodied as an application in a container, access to the memory area by using a memory management unit,
allocate to the transmitter a first virtual address by the memory management unit for access to the memory area,
transmit the message using a transmitter,
revoke access of the transmitter to the memory area by the memory management unit after transmission of the message,
for receiving, grant a receiver, which is embodied as an application in a container, access to the memory area by allocating to the receiver a second virtual address obtained from the memory management unit for access to the memory area, with the first virtual address being different from the second virtual address, and
read the data from the memory area with the receiver using the second virtual address.

21. A non-transitory computer-readable storage medium comprising a computer program with commands which, when the commands are read into a memory of a computing system and executed by a processor of the computing system, cause the computing system to.
write data into a memory area of a plurality of memory areas,
grant a transmitter, which is embodied as an application in a container, access to the memory area by using a memory management unit,
allocate to the transmitter a first virtual address by the memory management unit for access to the memory area,
transmit the message using a transmitter,
revoke access of the transmitter to the memory area by the memory management unit after transmission of the message,
for receiving, grant a receiver, which is embodied as an application in a container, access to the memory area by allocating to the receiver a second virtual address obtained from the memory management unit for access to the memory area, with the first virtual address being different from the second virtual address, and
read the data from the memory area with the receiver using the second virtual address.
